(19) United States
(12) Patent Application Publication
(10) Pub. No.: US 2008/0197011 A1
(43) Pub. Date: Aug. 21, 2008

(54) Foil-Type Pressure Sensor Adapted For Minimizing Critical Preload Issues

(75) Inventors: Alain Noll, Gouvy (BE); Yves Decoster, Ethe (BE)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., Echternach (LU)

(21) Appl. No.: 11/577,416

(22) PCT Filed: Oct. 13, 2005
(86) PCT No.: PCT/EP05/55237

§ 371 Date: Apr. 18, 2007

(30) Foreign Application Priority Data
Oct. 18, 2004 (EP) 04105122.8

(51) Int. Cl. H01H 35/00

(52) U.S. Cl. 200/85 R

(57) ABSTRACT

A foil-type switching element comprises a first carrier foil and a second carrier foil arranged at a certain distance by means of an inner spacer. The inner spacer comprises at least one cut-out defining an active area of said switching element where at least two electrode structures are arranged between said first and second carrier foil so as to define at least one pair of spaced switch contacts. According to the invention, the switching element further comprises a first outer spacer layer, said first outer spacer layer being arranged on an outer surface of said first carrier foil and said first outer spacer layer comprising at least one opening in the region of said active area. In a preferred embodiment of the invention, the foil-type switching element further comprises a second outer spacer layer, said second outer spacer layer being arranged on an outer surface of said second carrier foil and said second outer spacer layer comprising at least one opening in the region of said active area.

The present invention relates generally to a foil type switching element and more specifically to a foil-type switching element suitable for being integrated into a vehicle seat or a foil-type pressure cell which is optimized in order to minimize critical preload issues.

The present invention relates to a foil-type switching element comprising a first carrier foil and a second carrier foil arranged at a certain distance from each other by means of an inner spacer. The inner spacer comprises at least one cut-out, which defines an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes.

Several embodiments of such foil-type switching elements are well known in the art. Some of these switching elements are configured as simple switches comprising e.g. a first electrode arranged on the first carrier foil and a second electrode arranged on the second carrier foil in a facing relationship with the first planar electrode. The electrodes may be of a planar configuration covering essentially the entire surface of the respective carrier foil inside of the active area.

Other switching elements known in the art are configured as pressure sensors having an electrical resistance, which varies with the amount of pressure applied. In a first embodiment of such pressure sensors, a first electrode is arranged on the first carrier foil and a second electrode is arranged on the second carrier foil in facing relationship with the first electrode. At least one of the electrodes is covered by a layer of pressure sensitive material, e.g. a semi-conducting material, such that when the first and second carrier foils are pressed together in response of a force acting on the switching element, an electrical contact is established between the first and second electrode via the layer of pressure sensitive material. The pressure sensors of this type are frequently called to operate in a so called “through mode”.

In an alternative embodiment of the pressure sensors, a first and a second electrode are arranged in spaced relationship on one of the first and second carrier foils while the other carrier foil is covered with a layer of pressure sensitive material. The layer of pressure sensitive material is arranged in facing relationship to the first and second electrode such that, when said first and second carrier foils are pressed together in response to a force acting on the active area of the switching element, the layer of pressure sensitive material shunts the first and second electrode. These sensors are called to operate in the so-called “shunt mode”.

The above-described switching elements can be manufactured cost-effectively and have proven to be extremely robust and reliable in practice. Due to these positive properties, foil-type switching elements are nowadays widely used in all kinds of switching and sensing applications. The sensors or switching elements offer a very slim profile and low weight which makes the switching elements suitable for integration in various operating environments.

One specific application for these foil-type switching elements includes seat sensors for sensing an occupancy status e.g. of a vehicle seat, the determined occupancy status being used for controlling a secondary restraint system of for triggering a seat belt reminder. Seat sensors comprising usually a plurality of foil-type switching elements are typically assembled in the car seat between the seat trim and the foam cushion of the seat. As the seat trim is usually rather rigid and/or strongly taut above the seat sensors, the switching elements are pressed against the seat cushion below the switching elements. Alternatively, the seat sensors are placed inside the cushion foam of the seat at a certain depth from the top side of the cushion. The seat sensors are e.g. placed inside a cut carried out laterally into the seat cushion.

Both integration variants lead to a permanent contact between the foam and the switching element, which leads to an undesired preload on the switching element active area, especially in the case of switching elements having a high sensibility. Due to this direct and permanent contact between the active area of the switching element and the seat material, a drift of sensitivity is observed during lifetime of the seat sensor.

### OBJECT OF THE INVENTION

The object of the present invention is to provide an improved foil-type switching element which is well suited for being integrated into a flexible material e.g. into a foam material.

### GENERAL DESCRIPTION OF THE INVENTION

In order to overcome the abovementioned problems, the present invention proposes a foil-type switching element comprising a first carrier foil and a second carrier foil arranged at a certain distance by means of an inner spacer, wherein said inner spacer comprises at least one cut-out defining an active area of said switching element where at least two electrode structures are arranged between said first and second carrier foil so as to define at least one pair of spaced switch contacts. According to the invention, the switching element further comprises a first outer spacer layer, said first outer spacer layer being arranged on an outer surface of said first carrier foil and said first outer spacer layer comprising at least one opening in the region of said active area.

The outer spacer layer of the switching element of the present invention separates the flexible material of the sensor environment from the first carrier foil and thus prevents the flexible material to act directly on the active area of the switching element even when no outer force acts on the sensor environment. If however an outer force acts on the vehicle seat, the seat foam material may penetrate through the opening of the outer spacer layer under the action of the outer force and act on the active area of the switching element in order to activate the switching element.

In a preferred embodiment of the invention, the foil-type switching element further comprises a second outer spacer layer, said second outer spacer layer being arranged on an outer surface of said second carrier foil and said second outer spacer layer comprising at least one opening in the region of said active area. This embodiment of the switching element is specifically suitable for integration in an environment, where elastic material acts from both sides onto the switching element. It follows that this switching element is very well suited for the insertion into a cut performed into a seat cushion of a vehicle seat.

The outer spacer layer or layers of the present invention prevent(s) the switching element environment to act directly and permanently onto the switching element. It follows that the dynamic behaviour of the switching element is not affected by the constant action of the flexible material on the active area of the switching element. The actual switching element behaviour may accordingly be independently adjusted by suitably dimensioning the two carrier foils and the inner spacer according to the requirements of the switching element's later application. This adaptation of the switching behaviour or sensitivity of the switching element may be performed independently from the switching element's later operating environment. Once the switching behaviour is adjusted, the switching element may be adapted to the future operation environment by suitably dimensioning the outer spacer layer.

The switching element of the present invention thus enables an independent adjustment of the dynamic switching characteristic and an adaptation to the operating environment. The switching element may accordingly be much better adapted to the specific requirements of the actual application. Furthermore, once the switching characteristic of the switching element is adjusted, the switching element can easily be adapted to different operating environments without negatively affecting the switching characteristic.

The first and/or the second outer spacer layer may be manufactured from any suitable material like e.g. the same material than the inner spacer. In a preferred embodiment however, the first and/or the second outer spacer layer may comprise a more flexible material, like e.g. a felt layer. In contrast to an outer spacer layer manufactured from a plastic foil the use of a flexible material like a felt layer as outer spacer layer allows the provision of outer spacer layers having a high thickness without negatively affecting the overall flexibility of the switching element. An outer spacer made of a felt layer further provides additional advantages with respect to comfort, like e.g. noise reduction or reduced perceptibility, of the switching element once integrated into an vehicle seat. Finally the outer spacer layer made of a felt material is easy to manufacture.

The adaptation of the switching element to its specific operating environment is dependent of the characteristics of the elastic properties of the material surrounding the switching element in operation. If the behaviour of the elastic material of the sensor environment is supposed to be similar on both sides of the switching element, the first and second outer spacer layers will usually have a similar configuration. This means that a lateral dimension, e.g. a diameter in case of a circular opening, of said opening in said first outer spacer layer is equal to a lateral dimension of said opening in said second outer spacer layer and/or that a thickness of said first outer spacer layer is equal to a thickness of said second outer spacer layer.

In cases, where the switching element should be integrated into an environment, where a different material behaviour is to be expected on both sides of the switching element, the first and second outer spacer layers will preferably have a different configuration. In this case, a lateral dimension of said opening in said first outer spacer layer might be different from a lateral dimension of said opening in said second outer spacer layer. Additionally or alternatively a thickness of said first outer spacer layer could be different from a thickness of said second outer spacer layer.

The thickness of the outer spacer layers and the lateral dimension(s) of the respective openings are selected in dependence on the elastic properties of the environment material of the switching element and the pressure conditions acting in said elastic material. This means that in the presence of a soft foam material, the outer spacer layer should e.g. be thicker than in the presence of a harder foam material. The configuration of the outer spacer layers is chosen so that any direct contact between the seat material and the respective carrier foils 2006/042820 PCT/EP2005/055237 in the active area of the switching element is prevented when no outer force acts on the vehicle seat, i.e. when no occupant is sitting on the seat.

In order to enable the switching element to operate correctly in the presence of an outer force acting on the vehicle seat, the configuration of the outer spacer layers must enable the elastic material of the switching element environment to penetrate through the opening in the outer spacer layer and act on the active area under the action of the outer force. The lateral dimension of said opening in said first outer spacer layer and/or second outer spacer layer is therefore usually larger than a lateral dimension of said cut-out of said inner spacer, which means that the opening in said first outer spacer layer and/or second outer spacer layer is larger than the active area of the switching element. In a preferred embodiment, the opening in said first outer spacer layer and/or second outer spacer layer is e.g. dimensioned and arranged so that said opening completely overlaps said active area of said switching element.

In a preferred embodiment of the invention, the opening in said first outer spacer layer and/or second outer spacer layer is arranged coaxially with said cut-out of said inner spacer. The openings in the first and second outer spacer layers are accordingly symmetrically arranged with respect to the active area of the switching element. This configuration ensures, that the elastic material of the sensor environment, which penetrates into the opening of the outer spacer layers under the action of an external force, acts symmetrically on the active area so that a reliable activation of the switching element is ensured.

It will be appreciated, that the present invention is applicable to simple membrane switches having two distinct electrical states as well as to more sophisticated foil-type pressure sensors having a whole range of output values depending on the pressure acting on the switching element. In a preferred embodiment of the invention, the switching element is e.g. configured as a force sensing resistor.

It will further be appreciated, the first and/or second outer spacer layer may be mounted on the respective carrier foil by any suitable method, e.g. by gluing, thermo-bonding or the like. In a preferred embodiment, the outer spacer layer is laminated onto the respective carrier foil.

Finally, the skilled person will note, that the outer spacer layers do not necessarily need to cover the entire outer surface of the respective carrier foils. In fact it is sufficient, that the outer spacer layers cover a small area in the immediate vicinity of the active areas. The outer spacer layers could for instance simply comprise an annular spacer element, the thickness and the inner diameter of which are adapted for conferring the required switching element protection. The outer diameter of the annular spacer element is not critical for the function of the outer spacer layer.

### DETAILED DESCRIPTION WITH RESPECT TO THE FIGURES

The present invention will be more apparent from the following description of several not limiting embodiments with reference to the attached drawings, wherein

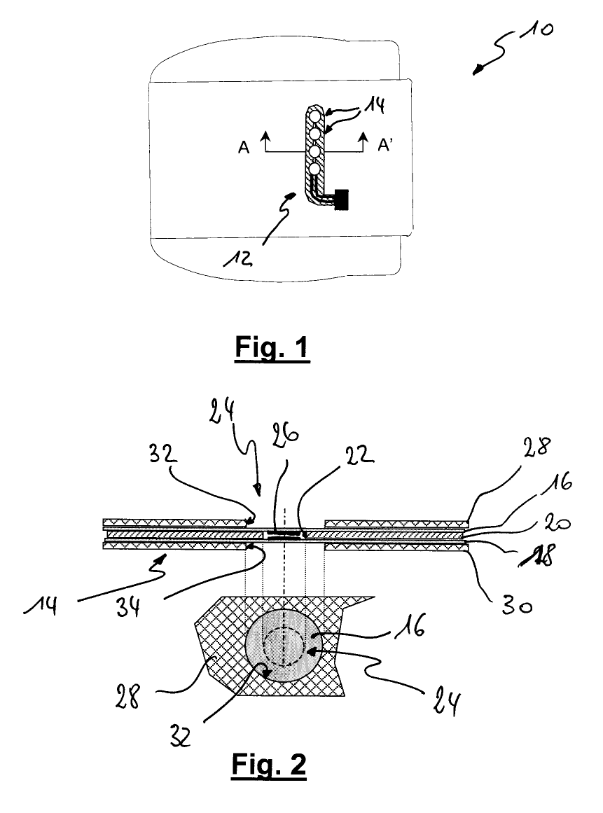

FIG. 1: schematically shows a vehicle seat and a seat sensor to be arranged therein;

FIG. 2: a cross section and a top view of a first embodiment of a foil-type switching element;

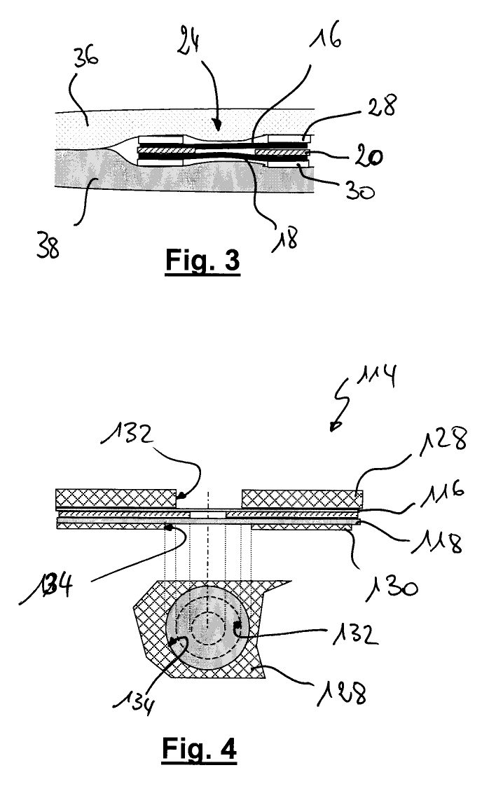

FIG. 3: a sectional view of a foil-type switching element integrated into a vehicle seat;

FIG. 4: a cross section and a top view of a second embodiment of a foil-type switching element.

FIG. 1 schematically shows a vehicle seat 10 and a seat sensor 12 to be integrated at the shown location into the vehicle seat 10. The shown seat sensor 12 is configured as passenger presence detector to be used in the control of a seat belt reminder system. This seat sensor 12 comprises several foil-type switching elements 14, which will be described in more detail with reference to FIG. 2.

Each foil-type switching element 14 comprises a first carrier foil 16 and a second carrier foil 18 arranged at a certain distance from each other by means of an inner spacer 20. The inner spacer 20 comprises at least one cut-out 22 defining an active area 24 of the switching element 12. Inside of the active area 24 at least two electrode structures 26 are arranged between said first and second carrier foil 16 and 18 so as to define at least one pair of spaced switch contacts. In the shown embodiment, one of said electrode structures 26 is arranged on each of the carrier foils 16 and 18 in such a way that the two electrode structures 26 face each other. If a pressure is acting on the switching element 14, the first and second carrier foils 16 and 18 are pressed together and, if the pressure exceeds a specific turn-on point, an electrical contact is established between the electrode structures 26.

It will be noted that the different switching elements 14 of the seat sensor 12 in the present embodiment are preferably manufactured using common carrier foils 16 and 18 as well as a common spacer layer, so that the individual switching elements 14 are linked together to form a combined seat sensor.

In the shown embodiment of FIG. 2, the switching element 14 comprises two outer spacer layers 28 and 30, manufactured e.g. from a felt material, which are arranged on the outer surfaces of the first and second carrier foils 16 and 18. Each of the outer spacer layers 28 and 30 comprises at least one cut-out or opening 32 and 34 in the region of the active area 24 of the switching element 14, so that in the active area 24, the first and second carrier foils are accessible from the outside of the switching element 14.

In the shown embodiment, the cut-out 22 of the inner spacer 20 and the respective cut-outs 32 and 34 of the outer spacers 28 and 30 all have a circular form and are coaxially arranged with respect to each other. This can be seen in the lower part of FIG. 2 which shows a top view of the switching element 14. It should however be noted that other forms for the cut-outs are possible and that the different cut-outs may have different shapes. Furthermore, the different cutouts are not necessarily arranged in a coaxial configuration.

The function of the outer spacers 28 and 30 will be apparent from FIG. 3, which shows a sectional view of a foil-type switching element 14 integrated into the vehicle seat 10. The switching element 14 shown in FIG. 3 is inserted in a cut of the vehicle seat so as to be arranged between two layers of resilient seat foam 36 and 38. The outer spacer layers 28 and 30 separate the flexible material of the two layers 36 and 38 from the respective carrier foils 16 and 18. As a result, the flexible material of the layers of seat foam 36 and 38 are prevented from acting directly on the active area 24 of the switching element 14 when no outer force acts on the sensor environment. As a result, preloads acting permanently on the switching element 14 (especially if the switching element is subjected to high temperatures etc) and the resulting sensor degradation can be effectively avoided.

The openings 32 and 34 of the outer spacers 28 and 30 enable the foam material to bulge towards the carrier foils 16 and 18, so that in the presence of an outer force acting on the switching element 14, the elastic material may penetrate through the opening 32 or 34 of the outer spacer layer 28 or 30 for acting on the respective carrier foils and thus may active the switching element 14.

FIG. 4 shows a different embodiment of a switching element 114, which may be used to adapt the switching characteristic to different properties of the switching element environment above and below the switching element.

In this embodiment, the first carrier foil 116 and the second carrier foil 118 have a different thickness. Likewise, outer spacer 128 has a different thickness than outer spacer 130. Further to the different thickness of the respective layers, the cut-outs 132 and 134 may have a different dimension, i.e. in the case of the shown circular cut-outs, opening 132 has a smaller diameter than opening 134. It should be noted that that openings 132 may also have a different shape than opening 134.

List of reference numerals

| | |
|---|---|
| 10 | vehicle seat |
| 12 | seat sensor |
| 14 | switching element |
| 16 | first carrier foil |
| 18 | second carrier foil |
| 20 | inner spacer |
| 22 | cut-out |
| 24 | active area |
| 26 | electrode structures |
| 28, 30 | outer spacer layers |
| 32, 34 | cut-out or opening |
| 36, 38 | layers of foam |
| 114 | switching element |
| 116 | first carrier foil |
| 118 | second carrier foil |
| 128 | outer spacer |
| 130 | outer spacer |
| 132, 134 | cut-outs |

1. Foil-type switching element comprising:
a first carrier foil and a second carrier foil arranged at a certain distance by means of an inner spacer, wherein said inner spacer comprises at least one cut-out defining an active area of said switching element where at least two electrode structures are arranged between said first and second carrier foil so as to define at least one pair of spaced switch contacts, and
a first and a second outer spacer layer, said first outer spacer layer being arranged on an outer surface of said first carrier foil and said second outer spacer layer being arranged on an outer surface of said second carrier foil, wherein each said first outer spacer layer and said second outer spacer layer comprises at least one opening in the region of said active area.

2. Foil-type switching element according to claim 1, wherein said opening in said first outer spacer layer and/or second outer spacer layer is arranged coaxially with said cut-out of said inner spacer.

3. Foil-type switching element according to claim 1, wherein a lateral dimension of said opening in said first outer spacer layer and/or second outer spacer layer is larger than a lateral dimension of said cut-out of said inner spacer.

4. Foil-type switching element according claim 1, wherein said opening in said first outer spacer layer and/or second outer spacer layer is dimensioned and arranged so that said opening completely overlaps said active area of said switching element.

5. Foil-type switching element according to claim 1, wherein a lateral dimension of said opening in said first outer spacer layer is different from a lateral dimension of said opening in said second outer spacer layer.

6. Foil-type switching element according to claim 1, wherein a lateral dimension of said opening in said first outer spacer layer is equal to a lateral dimension of said opening in said second outer spacer layer.

7. Foil-type switching element according to claim 1, wherein a thickness of said first outer spacer layer is different from a thickness of said second outer spacer layer.

8. Foil-type switching element according to claim 1, wherein a thickness of said first outer spacer layer is equal to a thickness of said second outer spacer layer.

9. Foil-type switching element according to claim 1, wherein said switching element is configured as a force sensing resistor.

10. Foil-type switching element according to claim 1, wherein said first outer spacer layer and/or second outer spacer layer comprises a felt layer.

11. Foil-type switching element comprising:
a first carrier foil and a second carrier foil, each having an inner surface and an outer surface, said first carrier foil and said second carrier foil being arranged at a certain distance by means of an inner spacer, wherein said inner spacer is arranged between said inner surfaces of said first and second carrier foils and comprises at least one cut-out defining an active area of said switching element;
at least two electrode structures arranged, in said active area of the switching element, between said first and second carrier foil so as to define at least one pair of spaced switch contacts, and
a first and a second outer spacer layer, said first outer spacer layer being arranged on said outer surface of said first carrier foil and said second outer spacer layer being arranged on said outer surface of said second carrier foil, wherein each said first outer spacer layer and said second outer spacer layer comprises at least one opening in the region of said active area.

12. Foil-type switching element according to claim 11, wherein said opening in said first outer spacer layer and/or second outer spacer layer is arranged coaxially with said cut-out of said inner spacer.

13. Foil-type switching element according to claim 11, wherein a lateral dimension of said opening in said first outer spacer layer and/or second outer spacer layer is larger than a lateral dimension of said cut-out of said inner spacer.

14. Foil-type switching element according claim 11, wherein said opening in said first outer spacer layer and/or second outer spacer layer is dimensioned and arranged so that said opening completely overlaps said active area of said switching element.

15. Foil-type switching element according to claim 11, wherein a lateral dimension of said opening in said first outer spacer layer is different from a lateral dimension of said opening in said second outer spacer layer.

16. Foil-type switching element according to claim 11, wherein a lateral dimension of said opening in said first outer spacer layer is equal to a lateral dimension of said opening in said second outer spacer layer.

17. Foil-type switching element according to claim 11, wherein a thickness of said first outer spacer layer is different from a thickness of said second outer spacer layer.

18. Foil-type switching element according to claim 11, wherein a thickness of said first outer spacer layer is equal to a thickness of said second outer spacer layer.

19. Foil-type switching element according to claim 11, wherein said switching element is configured as a force sensing resistor.

20. Foil-type switching element according to claim 11, wherein said first outer spacer layer and/or second outer spacer layer comprises a felt layer.
